(19) United States
(12) Patent Application Publication
(10) Pub. No.: US 2018/0240139 A1
(43) Pub. Date: Aug. 23, 2018

(54) REAL ESTATE PRICING ESTIMATE SYSTEMS AND METHODS

(71) Applicant: PINPUT LLC, Gilbert, AZ (US)

(72) Inventors: Christopher A. DENGLER, Queen Creek, AZ (US); Cameron J. NORMOYLE, Gilbert, AZ (US); Christopher R. Dengler, Queen Creek, AZ (US); Samantha D. Dengler, Queen Creek, AZ (US)

(21) Appl. No.: 15/873,858

(22) Filed: Jan. 17, 2018

Related U.S. Application Data
(60) Provisional application No. 62/446,952, filed on Jan. 17, 2017.

(51) Int. Cl. G06Q 30/02; G09B 29/00; G06Q 50/16

(52) U.S. Cl. CPC G06Q 30/0206; G06Q 50/16; G09B 29/007; G06Q 30/0205

(57) ABSTRACT

Systems and method of the present invention are directed to deriving a more accurate model for ascertaining the estimated price or value of real estate property (e.g., residential or commercial) based upon previously sold properties, geographical location of the subject property, and other factors.

### PRIORITY

This Application claims priority to and the benefit of U.S. Provisional Application No. 62/446,952, filed Jan. 17, 2017, which is fully incorporated herein by reference.

### TECHNICAL FIELD

The present invention relates generally to systems, methods, and computer programs for ascertaining the estimated price of real estate property.

### BACKGROUND OF THE INVENTION

Currently, there are various methods by which to determine housing pricing. For instance, U.S. Pat. No. 5,361,201 and U.S. Pat. No. 8,140,421 both illustrate the use of various models. In the end, however, conventional home pricing estimate systems are simply crude “estimates.” Arriving at a more accurate modeling method is the key to more accurate pricing, and something that is missing from conventional methodologies.

Accordingly, there exists a need for new, improved, and more efficient systems and methods for modeling estimated pricing of real estate property.

### SUMMARY OF THE INVENTION

Particular embodiments of the present invention are directed to deriving a more accurate model for ascertaining the estimated price or value of real estate property (e.g., residential homes or commercial properties) based upon previously sold properties, geographical location of the subject property, and other valuable factors.

First, pertinent data points (or meta data) of the subject property can be obtained to estimate its value. This includes such factors as lot size, number of rooms, number of baths, and the like. Then, a sample of data from previously sold listings (e.g., “comparables” or “comps”), or a sample of data from “currently for sale” listings, surrounding the subject property is obtained. “Outliers” are then eliminated using a variable standard deviation. If the system processes and determines that a value is a certain number of standard deviations away from the mean, that data point is identified as an outlier. The specified number of standard deviations is called the threshold. Typically, the comparables would be selected from the most recent sold data, or currently for sale data, within a certain area or distance (e.g., approximately 1 radial mile) from the subject property. However, larger or smaller distances and samples are envisioned for use with the present invention as well.

Next, a linear regression model is computed for each of the n parameters. Exemplary parameters can include, but are not limited to: lot size, square footage of property, number of bedrooms, number of baths, number of levels/stories, etc. For each parameter, a linear regression formula and a certain allowance for error (after elimination of outliers by means of limits set by variable standard deviation) can be processed and computed. By determining the percentage of error of each sample point, the system then determines how “far off” each data point is from the linear regression (line/formula). The greater the overall error of a linear regression, the less weight it is given in computing the final price estimation of the listing/subject property in question. The different weights of particular parameters accurately represents the varying degree of influence of each on the subject property's price, depending on the geographical location of the property and other factors.

Once these calculations have been completed, there will be a linear regression model/formula for each of the parameters and a respective weight for each parameter that will be used to determine how much each parameter's linear regression is considered in estimation of the final price of a particular property. Multiplying each price by its weighted percentage, the system then arrives at multiple prices for a particular property. Applying the respective weights to each estimation, and adding up the weighted estimates, provides the new estimate for the subject property.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows inputting, parameter weighting, system processing, and data outputs for a property estimate system and method, in accordance with embodiments of the present invention.

FIG. 2-3 show property area maps and target selections for a property estimate system and method, in accordance with embodiments of the present invention.

FIGS. 4-5 show linear regression scatter graphs for a property estimate system and method, in accordance with embodiments of the present invention.

### DETAILED DESCRIPTION

Exemplary methods, and computer programs, or software application systems 10 of the present invention are adapted to process property parameter data, process and determine weighting factors for each parameter, and display or otherwise output an estimated value for target real estate property.

Various hardware and software configurations for carrying out the disclosed methods and processes can be implemented without deviating from the spirit and scope of the present invention.

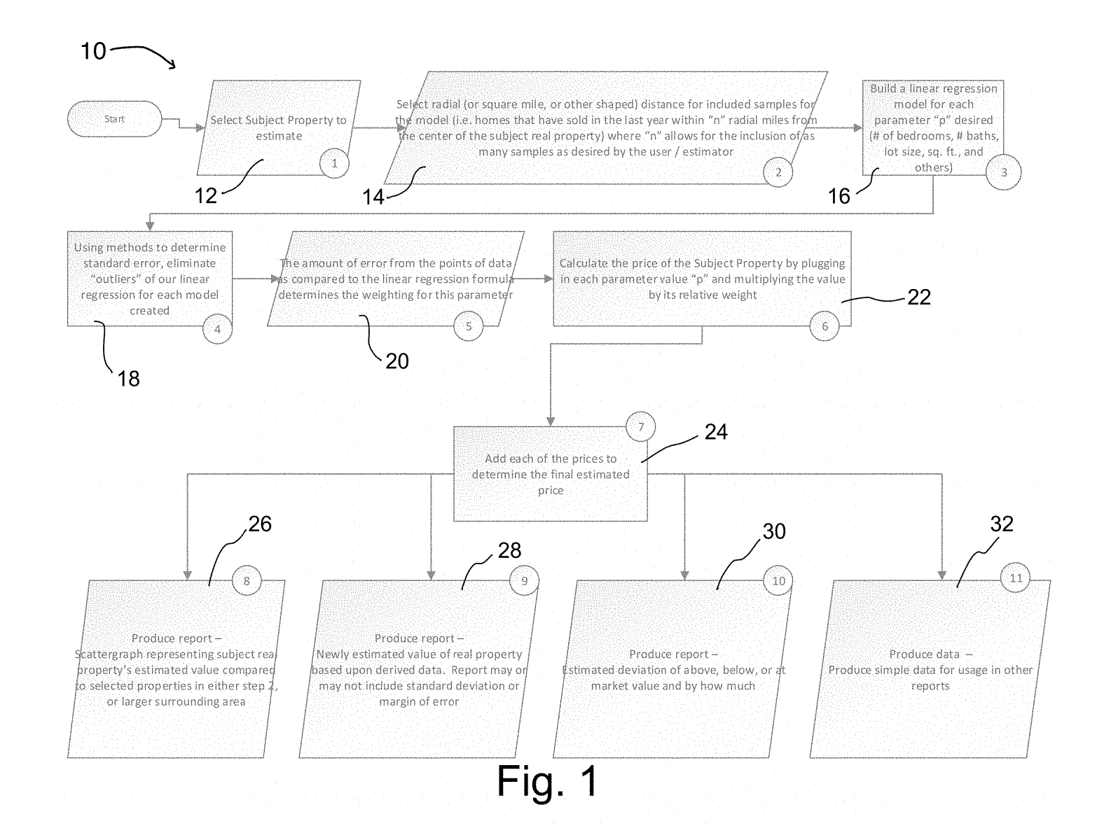

Referring to FIG. 1, exemplary method steps of the present invention are detailed. The system 10 can begin with the selection of the subject or target property P to estimate at step 12. Pertinent data points or meta data of the subject property are inputted or directed to the system 10 to estimate its value, such as lot size, number of rooms, number of baths, and the like. Then, a sample of sold data from other comparable listings surrounding the subject property is obtained. The meta data, sold data, and any other needed or relevant data, can be inputted, or obtained from a system 10 database, from a remote service or database, or from any system, service, or database in operable communication with the system 10.

At step 14, a user or computer input selects the distance (e.g., radial distance, or square miles, rectangular miles, etc.) for included property samples for the model—e.g., homes that have sold in the last year (or other time frames) within “n” distance, such as radial miles, from the center of the subject property—where “n” allows for the inclusion of as many samples, or sample data, as desired by the user or data input.

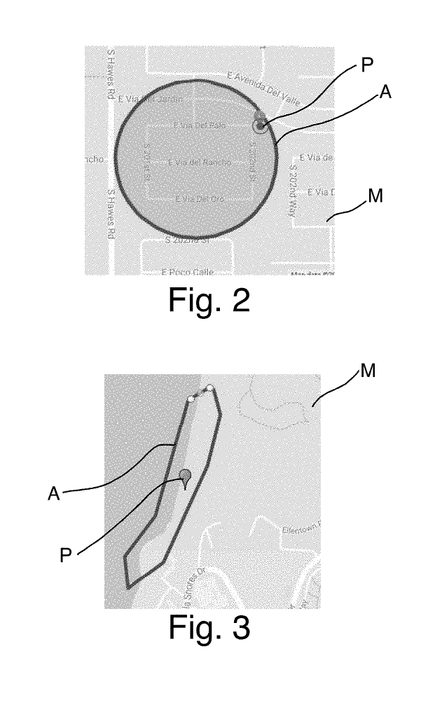

As shown in FIGS. 2-3, this selection can be inputted by the user using a displayed map M with target area A—such as a circle (FIG. 2), polygon (FIG. 3), etc. Square miles, radial miles, textual inputs, free-form drawing of an enclosed area, or other types of distance measurements and inputs can be provided to facilitate this selection without deviating from the spirit and scope of the present invention. A user can also simply select an entire state, a city, a zip code, a city block, and the like. In the end, a geo-location is selected by the user, or inputted via software, to define the sample base.

Additionally, the data representing each sample listing will contain the parameters of a listing (e.g., bedrooms, baths, size, etc.), as well as different or unique parameters for residential or commercial properties. The value of each sample listing can come from various sources, including (a) what the property has sold for in the past, or (b) what the property is currently selling for, or on the market for. A selection is made between (a) and/or (b), which can then be retrieved and processed for all of the prices for the rest of the samples. For example, a longitude −111.9261, latitude 33.4942 selection, which is in Scottsdale, Ariz., and a selection of those properties currently “for sale” within 3 radial miles of that location, will generate a search of MLS listings for sale for a given date—resultingly providing a plurality of current “for sale” listings in that target area.

Next, at steps 16-18, a linear regression model is computed for each of the n parameters, using each of the selected sold or “for sale” properties (e.g., residential homes). The system 10 can also, as detailed herein for certain embodiments, process and determine standard error, eliminate “outliers,” and the like. “Outliers” can be eliminated using a variable standard deviation. If a value is a certain number of standard deviations away from the mean, that data point is identified or flagged as an outlier. The specified number of standard deviations is identified as the threshold.

Exemplary parameters can include, but are not limited to: lot size, square footage of property, number of bedrooms, number of baths, number of levels/stories, parking lot size, and a myriad of other parameters relevant to property listings and interest. For each parameter, a linear regression formula, and a certain allowance for standard error based upon the standard deviation, can be computed. As shown at step 20, the amount of error from the points of data is compared to the linear regression formula to determine the weighting of the parameters.

The percentage of error in each linear regression can then be determined. The greater the error, the less weight it is assigned by the system 10 in final estimation of the price of the listing/subject property in question. The parameters are processed and weighted because each has a varying degree of influence on the subject property's price, depending on the geographical location of the property and other factors.

For instance, square footage of a home in San Francisco may have a much greater influence on value than it does on a home in Arizona. Similarly, lot sizes may have a more significant factor for ocean-front property than for rural or countryside properties. Each of the respective ‘errors’ can be summed up together into a new value, “y”. The system 10 then takes and processes the error of each linear regression (e.g., one for each parameter being used) and divides by “y”, thereby determining the final relative weight of each parameter in the final estimation of the price of the property in question.

Once these calculations have been completed, the system 10 will have a linear regression model/formula for each of the parameters, as well as the weight that each parameter will apply to its own linear regression model. The following is a linear regression model of properties in a sample area, in accordance with certain embodiments of the present invention:

$$\begin{matrix}a = \frac{( \sum y ) ( \sum {x}^{2} ) - ( \sum x ) ( \sum xy )}{n ( \sum {x}^{2} ) - {( \sum x )}^{2}} & \\ b = \frac{n ( \sum xy ) - ( \sum x ) ( \sum y )}{n ( \sum {x}^{2} ) - {( \sum x )}^{2}} & \end{matrix}$$

As an example, if it is determined that the linear regression formula for square footage is:

y=252.39x−145627

and it is determined that the weight of the square footage parameter is 65%, and it is known that the subject property is 2,000 square feet, then the system 10 will apply 2,000 to x in the formula and arrive at:

y=252.39(2000)−145627

This provides a price of $359,153.00. However, this parameter only applies with a weight of 65%. Determining the other prices of the other parameters, the system 10 will end up with n number of formulas, with n number of weights. In the immediately-proceeding example, the system 10 processes, calculates, and ends up with four values and weights, by standard deviation, represented with the following exemplary values:
$359,153.00 at 65%—square footage
$327,253.00 at 15%—lot size
$289,251.00 at 10%—number of bedrooms
$370,935.00 at 10%—number of bathrooms

Processing and multiplying each price by its weighted percentage, the system 10 then arrives at four (or “n”) prices (step 22). It should be noted that additional parameters may be used, with these specific four provided merely as an example. Further, while this weighting determination is an optional system step, it can greatly increase the accuracy of the calculations. The user may desire to weigh each parameter equally, or that user may have determined a different method by which to weigh each formula.

Adding up those final prices produces the new estimate for the subject property (step 24).

### SPECIFIC EXAMPLE

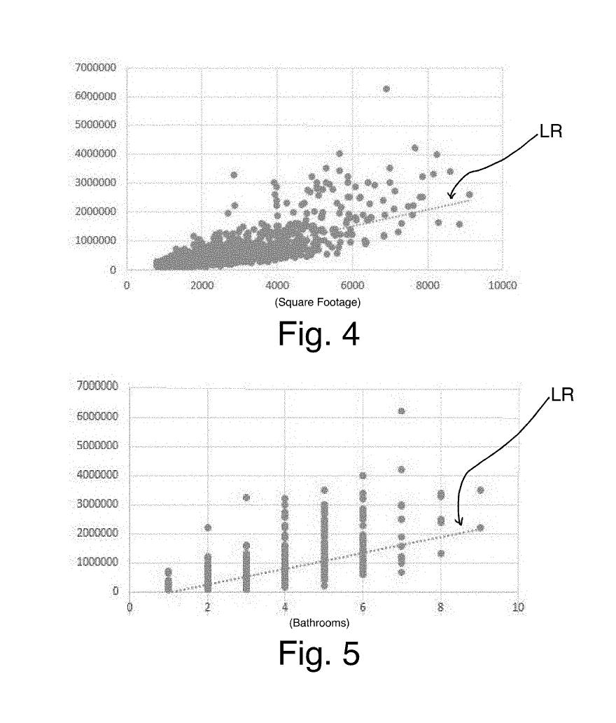

According to the example for Scottsdale (longitude −111.9261, latitude 33.4942 geo-location) target area referenced above, the system 10 may arrive at the following linear regression formulas for each of the parameters:
y=949285.8683502316x−1719097.7267492802 (number of bedrooms)
y=867255.8395747668x−1461620.8718426342 (number of bathrooms)
y=1994990.7795422582x+428312.3101282765 (lot size)
y=645.5222322293x−638098.7346319178 (square footage/living area)
   Using these formulas, the system 10 can process and graph (e.g., scatter graph) each of the sample listings for each parameter, as illustrated in FIG. 4-5. FIG. 4 provides a graph of the linear regression for the “square footage” and FIG. 5 provides a graph of the linear regression for the “number of bathrooms.” The linear regression line is represented as LR in the graphs. Of course, these linear regressions can be calculated and processed for each of the considered parameters.

Looking at step 22 for this example, the following are the parameters for the subject property: number of bedrooms=3, number of bathrooms=2, lot size=0.8 acres, and square footage/living area=4106 square feet. Using and processing these values into the system's linear regression formula from step 16, the following price values are calculated:
y=949285.8683502316(3)−1719097.7267492802 (bedrooms)=$4,566,955.33
y=867255.8395747668(2)−1461620.8718426342 (baths)=$3,196.132.55
y=1994990.7795422582(0.8)+428312.3101282765 (lot size)=$2,024,304.93
y=645.5222322293(4106)−638098.7346319178 (square footage/living area)=$3,288,613.02

Looking further at this “Scottsdale” example, the weighting of the calculated prices is provided, including multiplying the price to its corresponding determined weight:
$4,566,955.33*22.6644%=$1,035,073
$3,196.132.55*21.9978%=$703,078
$2,024,304.93*26.9973%=$546,507
$3,288,613.02*28.3305%=$931,680
   Adding these four values together, the system 10 arrives at a value of $3,216,338 for the subject property. Again, this specific example is provided for illustrative purposes to demonstrate the processing and methodology of the system 10 and is not intended to be at all limiting.

The system 10 can then process and output or produce various reports at steps 26-32. For instance, a scatter graph report representing the subject property's estimated value compared to selected properties (or larger surrounding area) can be produced at step 26. Again, exemplary outputted and displayed scatter graphs are shown in FIGS. 4-5. Anything below the linear regression line LR can represent a value below the estimated value and anything above the linear regression line LR can represent a value that would be higher priced than the estimate. In addition, scatter graphs can also represent more than a single property, instead representing all of the listings, or a defined set of listings or “comps,” in a given selected area in order to determine undervalued homes (e.g., in a particular zip code, state, etc.). Anything below the linear regression line represents an undervalued estimate for what that listing either sold for, or is currently selling for.

Similarly, a report including the newly estimated value of the property based upon derived data can be processed and displayed at step 28. This report can include standard deviation or margin of error data. Another generated report can include estimated deviation of above, below, or at market values, and the extent of the deviation for each (step 30).

The following are exemplary output reports in accordance with embodiments of the system 10 of the present invention and are not intended to be limiting:
Process and determine the most undervalued home for sale in an area (e.g., Tempe, Ariz.; City, State; etc.). This would produce a linear regression model of the subject homes that have sold in the area, and apply existing for-sale subject properties to the linear regression model to determine overpriced or underpriced homes, in a given area.
Process and produce a list of the top 10 undervalued homes within a given radial (or square) distance (e.g., miles) of the Golden Gate Bridge between $1,000,000 and $1,200,000.
Process and determine the value of a subject property about to go on the market.
Process and determine the value of a subject property that is already on the market, or has been on the market to determine the possible reason (pricing) for it going unsold.

Of course, a myriad of other reports and data can be generated and outputted based on the system 10 processing. In addition, date of sale, and the processing of increases or decreases in home values in sample size per month, year, etc., can be applied to the final linear regression model of sample properties.

Step 32 can include outputting, producing, or displaying raw data, such as inputted and processed data from the system 10, that can be used in other reports and various outputs.

Further, each of the methods and steps provided above can additionally use historical data for pricing provided that the amount of inflation/deflation is processed and taken into consideration by the system 10 for a given area. For instance, to use pricing data for some of the properties from 10 years ago, the system 10 would apply the amount of property value increase over last 10 years to each corresponding listing.

Various devices or computing systems can be included and adapted to process and carry out the aspects, steps, methods, computations, and algorithmic processing of the system 10 of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with the network, other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the devices include a microprocessor, computer readable program code may be stored in a computer readable medium or memory, such as, but not limited to storage media (e.g., a hard disk or solid-state drive), optical media, memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The computing devices may include an input device. The input device is configured to receive an input from either a user or a hardware or software component—as disclosed herein in connection with the various user interface or data inputs. Examples of an input device include a keyboard, mouse, microphone, touch screen and software enabling interaction with a touch screen, etc. The devices can also include an output device. Examples of output devices include monitors, televisions, mobile device screens, tablet screens, speakers, remote screens, etc. The output device can be configured to display images, media files, text, or video, or play audio to a user through speaker output.

Server processing systems, for use or connected with the system 10 of the present invention, can include one or more microprocessors, and/or one or more circuits, such as an application specific integrated circuit (ASIC), field-programmable gate arrays (FPGAs), etc. A network interface can be configured to enable communication with the network, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to storage media (e.g., a hard disk or solid-state drive), optical media, memory devices, etc.

The present invention can be embodied as software code residing on a user's computing device (e.g., desktop, tablet, mobile, and the like) and/or on the server. The various data of the present invention can be included on and transferred to and from a storage area network (SAN), a data cloud, or any computing device for storing the file or files being uploaded, downloaded, or processed.

Aspects of the software code of the invention can take the form of a web app, a website interface, or a plugin or app, and can interface with various protocols or software using APIs or other means of interacting with computing software and systems.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A method for estimating property value, comprising:
selecting a subject property to estimate;
selecting a target area around the subject property;
selecting properties in the target area to be used as comparables for linear regression;
selecting one or more property parameters;
building a linear regression model for each of the one or more property parameters from the target area; and
determining a final estimated price for the subject property based on processing of the one or more property parameters with weighted linear regression formulas.

2. The method of claim 1, wherein selecting the target area includes selecting a generally circular boundary around the subject property on a displayed map.

3. The method of claim 1, wherein selecting the target area includes selecting a free-form boundary around the subject property on a displayed map.

4. The method of claim 1, further including determining a percentage of error for the linear regression model for each of the one or more property parameters.

5. The method of claim 1, wherein the one or more property parameters includes number of bedrooms data for the subject property.

6. The method of claim 1, wherein the one or more property parameters includes square footage data for the subject property.

7. The method of claim 1, wherein the one or more property parameters includes number of bathrooms data for the subject property.

8. The method of claim 1, further including outputting one or more reports.

9. The method of claim 8, wherein the one or more reports includes a scatter graph report.

10. The method of claim 8, wherein the one or more reports includes an estimated property value report.

11. The method of claim 8, wherein the one or more reports includes an estimated deviation report.

12. A system to estimate real estate property value, comprising:
a non-transitory memory;
a processor operatively coupled with the non-transitory memory and configured to;
select a subject property to estimate;
select a target area around the subject property;
select properties in the target area to be used as comparables for linear regression;
select one or more property parameters;
build a linear regression model for each of the one or more property parameters from the target area; and
determine a final estimated price for the subject property based on processing of the one or more property parameters with weighted linear regression formulas.
